(19) United States
(12) Patent Application Publication
(10) Pub. No.: US 2003/0091187 A1
(43) Pub. Date: May 15, 2003

(54) Apparatus and method for reading or writing user data

(76) Inventors: Wilhelmus Fransiscus Johannes Fontijn, Eindhoven (NL); Ronald Marcel Tol, Eindhoven (NL); Antonius Adriaan Maria Staring, Eindhoven (NL); Menno Anne Treffers, Eindhoven (NL)

Correspondence Address: U.S. Philips Corporation, 580 White Plains Road, Tarrytown, NY, 10591, US

(21) Appl. No.: 10/266,324

(22) Filed: Oct. 8, 2002

(30) Foreign Application Priority Data
Oct. 12, 2001 (EP) 01203908.7

(51) Int. Cl. H04N 7/167

(52) U.S. Cl. 380/201

(57) ABSTRACT

The invention relates to an apparatus for reading user data stored block-wise in encrypted form on a storage medium (4), the storage of which is divided into blocks, to an apparatus for writing user data block-wise onto a storage medium (4) and to corresponding methods. In order to inform the apparatus for read or writing, respectively, on the intended use of said user data, particularly if the user data is stored on the storage medium in encrypted form to inform the apparatus for reading about the encryption key for encrypting the user data before writing it on the storage medium or to inform the apparatus for writing about the decryption key for decryption the read user data before outputting it, it is proposed according to the present invention to add a processing information to the read or write command specifying how to process the user data and to provide processing means for processing the user data according to said processing information, e.g. to decrypt the read user data before outputting it or to encrypt the received user data before storing it on the storage medium.

The invention relates to an apparatus for reading user data stored block-wise in encrypted form on a storage medium, the storage of which is divided into blocks. The invention relates further to an apparatus for writing user data block-wise onto a storage medium, to corresponding methods of reading or writing user data and to a computer program product. The invention refers particularly to the protection of information on recordable storage media, particularly optical recording media like a CD or a DVD for storing any kind of data like video data or audio data.

If user data, e.g. video data, audio data, software or application data, is stored on a recording medium in encrypted form, it is most often required that an authorized application can read and use said user data, if allowed, from the recording medium without the need to retrieve the decryption key from a separate location such as the internet. Hence, the decryption key has to be stored on the medium, on which the encrypted user data is stored. In order to prevent unauthorized access to the decryption key, e.g. by unauthorized applications, the decryption key is generally hidden on the storage medium such that unauthorized applications cannot read the decryption key. Known methods for hiding the decryption key on the storage medium are the Content Scrambling System (CSS) and Content Protection for Recordable Media (CPRM).

Generally, the storage of a storage medium is divided into blocks (or sectors), and the content of a file is stored in one or more of such blocks. A read or a write command generally only specifies a logical block address, but not the name of the file that shall be read or written. Since each file, but not each block, has its own encryption or decryption key, an apparatus for reading or writing user data that receives a read or write command, e.g. from a PC application, cannot determine which key data to use for decryption or encryption since it does not receive the name of the file from the read or write command.

One possible solution would be to use the same key data for all user data stored on a storage medium. However, this solution is not acceptable if different keys are required for different files, as is needed in most applications.

Another possible solution would be to use a separate command to inform the reading or writing apparatus which key data to use in future read or write commands. However, this solution is also not acceptable in general, because it shall be possible for several applications to send commands to the reading or writing apparatus concurrently, each application reading and/or writing different files using different keys. With such a solution only a single application would be able to access the reading or writing apparatus, but other applications would have to be excluded unless they read the same file using the same key.

Generally, it is often required that certain processing steps are performed in the apparatus for reading or writing user data instead of in a PC application.

It is therefore an object of the present invention to provide an apparatus for reading and an apparatus for writing user data as well as corresponding methods of reading or writing user data which overcome the above mentioned problems but provide a high level of protection, against theft of any data through hacking of a PC application.

This object is achieved by providing an apparatus for reading as claimed in claim 1, comprising:

a command interface for receiving and interpreting a read command, said read command including a user data information specifying which user data are to be read and a processing information specifying how to process said user data,

reading means for reading user data from said storage medium,

processing means for processing said user data according to said processing information, and

output means for outputting said processed user data.

This object is further achieved by an apparatus for writing user data as claimed in claim 8, comprising:

a command interface for receiving and interpreting a write command, said write command including a user data information specifying which user data are to be written and a processing information specifying how to process said user data,

processing means for processing said user data according to said processing information, and

writing means for writing said processed user data onto said storage medium.

The object is still further achieved by corresponding methods as claimed in claim 7 and claim 13. A computer program product comprising computer program code means for causing a computer to perform the steps of the method as claimed in claim 7 or claim 13 when said computer program is run on a computer is claimed in claim 14.

The present invention is based on the idea to attach extra information to each read and write command forwarded to the apparatus for reading or writing user data, e.g. from a PC application. A read command thus does not only include the user data information specifying which user data are to be read, but also a processing information on the intended (future) use of said user data after reading it from the storage medium and before outputting it, e.g. to the PC application. Similarly, a write command does not only include a user data information specifying which user data are to be written, but also such a processing information on the intended (future) use of said user data before storing it on the storage medium. The user data information may thereby comprise the user data itself but also the logical block address specifying where to start reading or writing on the recording medium. In addition, the amount of data to read or to write may be comprised in such a read or write command. However, the user data itself may also be transmitted separate from the read or write command.

Based on the processing information the apparatus for reading or writing, respectively, is able to take appropriate action on the user data, preferably such as decryption, encryption, re-encryption, employ a specific allocation strategy, real-time characteristics, acceptable number of retries on a read error etc.

According to a preferred embodiment said processing information—included in a read command—contains a key data information specifying which key data to use for decrypting said user data, according to which said user data are decrypted before outputting it. Similarly, the processing information included in a write command contains a key data information specifying which key data to use for encrypting said user data, according to which the user data are encrypted before storing it on the storage medium in encrypted form. Since the key data itself are not known to a PC application receiving or outputting, respectively, the user data, said key data are securely protected against theft by a hacker. In addition, re-encryption of user data can be implemented by the apparatus for reading before transmitting it to a PC application, thus further protecting the user data against unwanted access during transmission.

According to another preferred embodiment the key data to be used for decrypting or encrypting said user data are included in the read or write command, said key data being included in encrypted form. This possibility is preferably only used when the PC application is trusted enough for it to be allowed to know the key data. Since the key data are only known to the PC application in encrypted form, the PC application does not really know what kind of data it is including into the read or write command sent to the apparatus for reading or writing.

According to another preferred embodiment a key data identifier identifying the key data to be read from the storage medium and to be used for decrypting or encrypting said user data, is included in the read or write command. Said key data are stored in encrypted form on the storage medium, e.g. in a table of content (TOC) which can be read by an application and which enables the application to relate key identifiers to files. Alternatively, the file name of the encrypted file may contain a key data identifier that the application can send and that the reading or writing apparatus can relate to a specific key of the set of keys stored on the storage medium. Generally, also a Secure Authenticated Channel (SAC) may be established between the reading or writing apparatus and the (trusted) application. This channel can then be used to communicate key data or a key data identifier.

According to still another embodiment of the invention re-encryption is done in the apparatus for reading after decrypting the user data read from the storage medium and before outputting the user data in re-encrypted form. In order to enable the apparatus for reading to re-encrypt the decrypted user data a re-encryption key data information is included in a read command specifying which re-encryption key data to use for re-encryption.

The invention will now be explained in more detail with reference to the drawings, in which

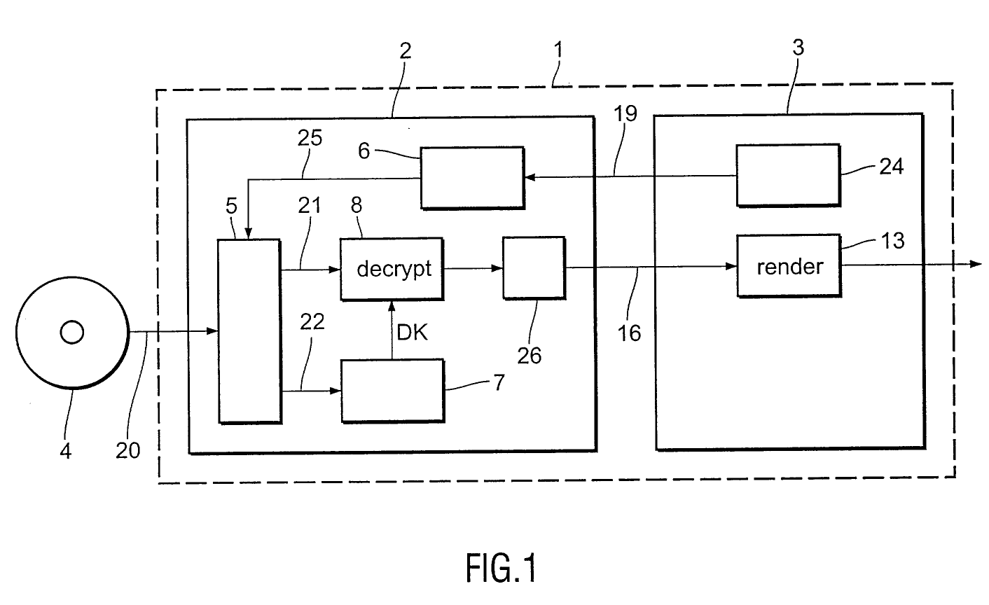

FIG. 1 shows a block diagram of a reproducing apparatus according to the invention,

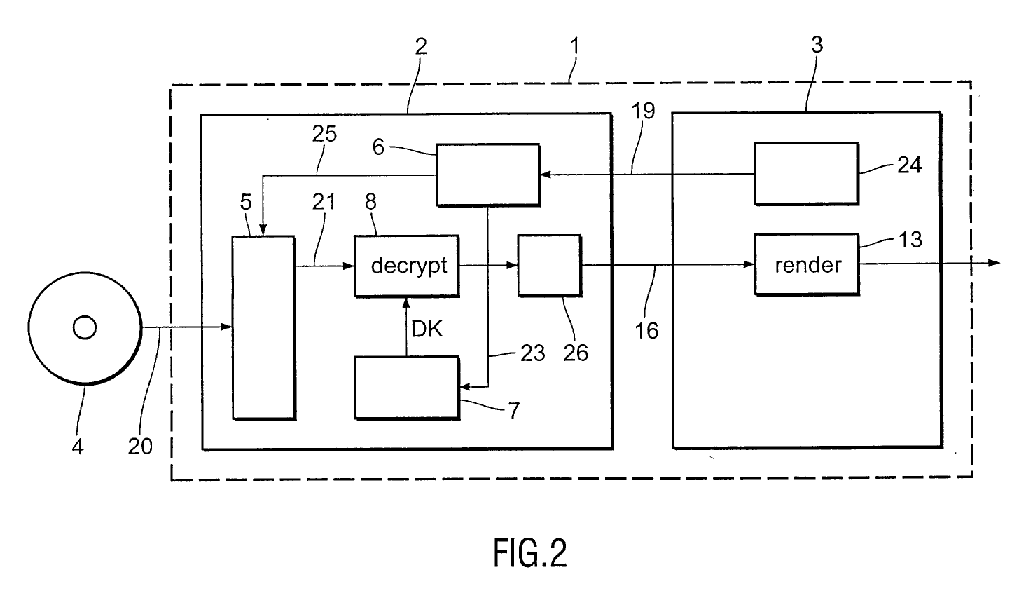

FIG. 2 shows a block diagram of a second embodiment of a reproducing apparatus,

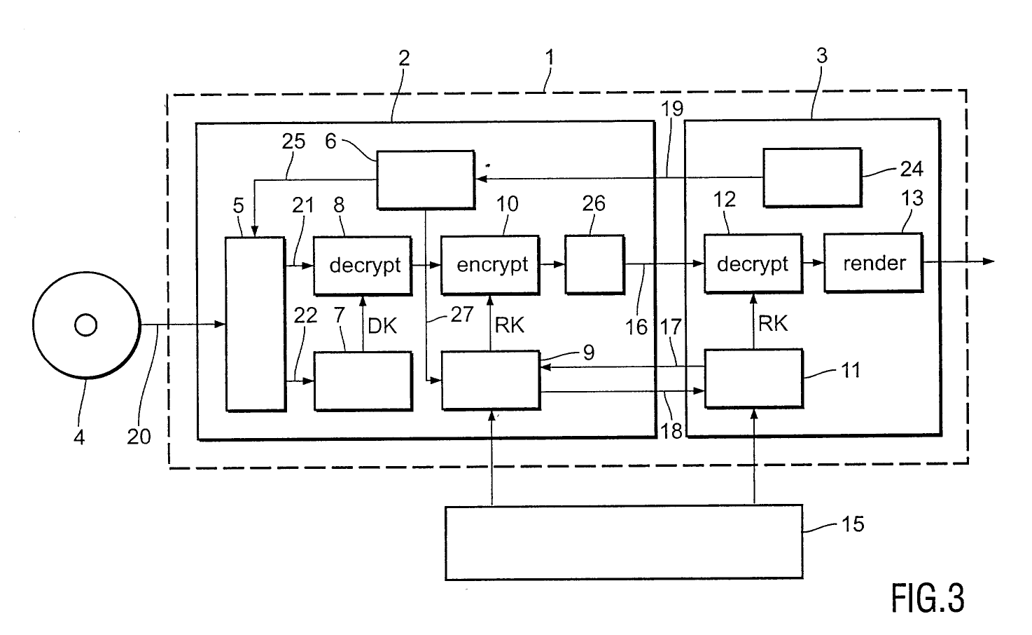

FIG. 3 shows a block diagram of a third embodiment of a reproducing apparatus,

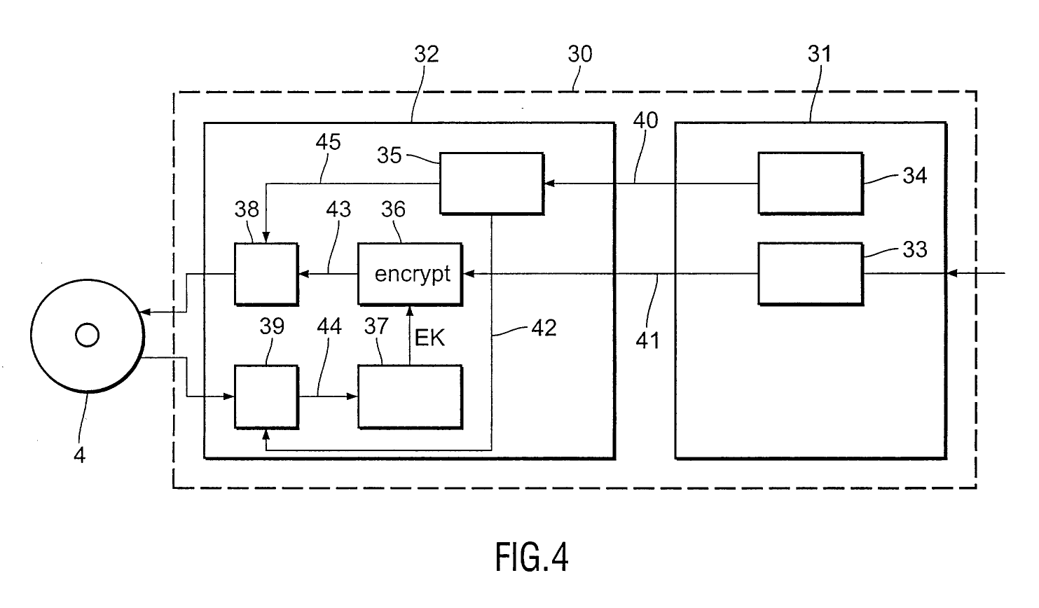

FIG. 4 shows a block diagram of a recording apparatus according to the invention,

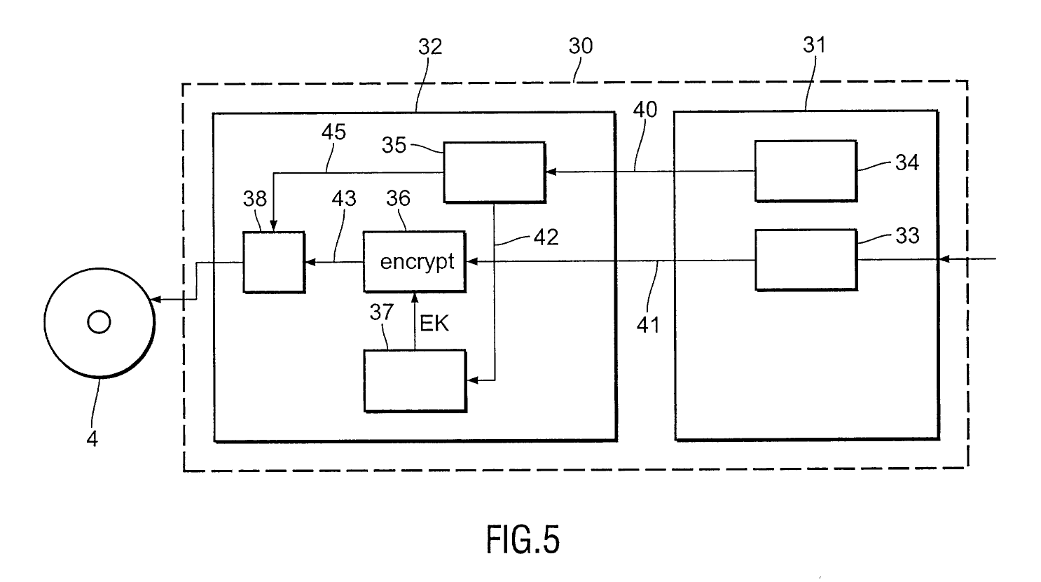

FIG. 5 shows a block diagram of a second embodiment of a recording apparatus and

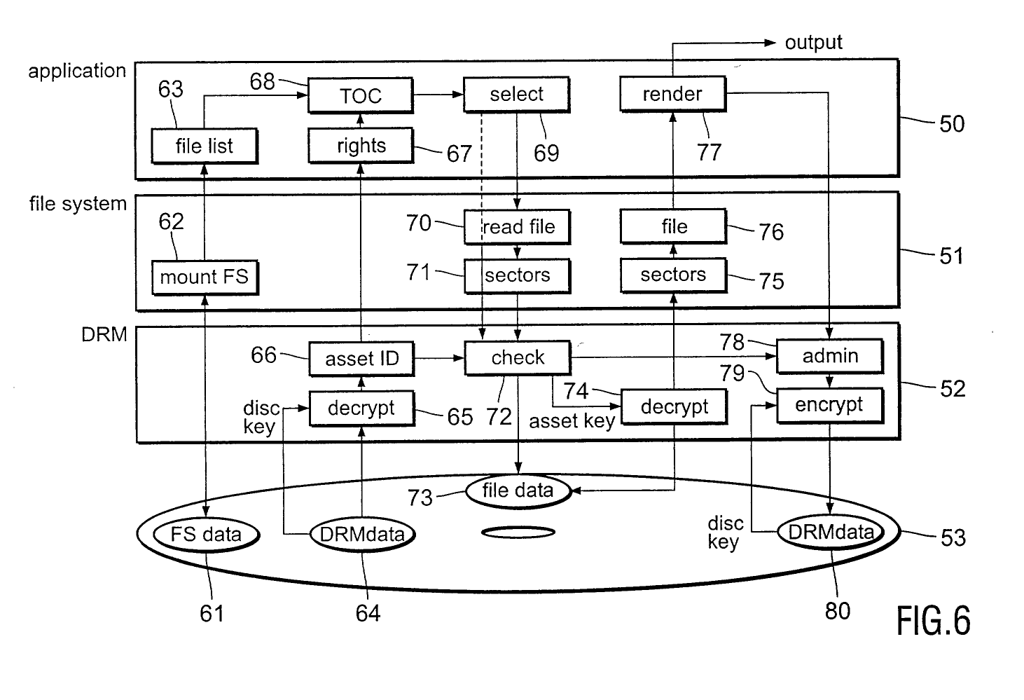

FIG. 6 illustrates the read operation according to the invention.

In FIG. 1 a first embodiment of a reproducing apparatus 1 according to the invention is illustrated. The reproducing apparatus 1 may be implemented on a personal computer comprising a drive unit 2, i.e. a reading apparatus, and an application unit 3 for running an application. If a user intends to reproduce user data stored on a recording medium 4 like a DVD-ROM, e.g. in order to replay video data stored on a DVD in MPEG-format, the medium 4 is inserted into the drive 2 where data 20 including said user data 21 and key data 22 are read by reading means 5. It should be noted that both the user data 21 and the key data 22 are stored on the medium 4 in encrypted form, and further, that there are different ways of encrypting user data and key data before storing it on the recording medium, but that it is not relevant for the present invention which particular way of encryption is used.

The storage of the medium 4 is divided into logical blocks each being addressable by a logical block address. Each file, the data of which are stored in one or more of such blocks, is associated with an encryption key, but not each block. Thus, the reading means 5 need to be informed about which encryption key to use for decrypting the user data 21 read from the medium 4.

If the application unit 3 requests the drive 2 to read certain user data 21, i.e. a certain file, from the medium 4 a command unit 24 sends a read command 19 to the command interface 6. The read command 19 which may be established in conformity with the SCSI Multi Media Commands-2 (MMC-2) or the SCSI-3 Block Commands (SBC) thereby includes the logical block address indicating the start of reading from the medium 4 and the amount of data to be read. In addition, a key data identifier is included identifying which encryption key shall be read from the medium 4 and shall be used for decryption. This information 25 is forwarded to the reading means 5 for enabling it to read the requested user data 21 and key data 22.

The read key data 22 are after reading inputted into a key calculation unit 7 for calculating the decryption key DK required by the decryption unit 8 for decrypting the read user data 21 provided from the reading means 5. The decryption key DK is identical to an encryption key which has been used for encrypting the user data before storing it on the medium 4 or is a corresponding key to this encryption key.

After decryption the decrypted user data 16 is transmitted to the application unit 3 by output means 26. Thereafter the requested user data can be completely reproduced and rendered for playback by render unit 13.

In another embodiment of a reproducing apparatus 1 according to the invention as shown in FIG. 2 the key data required for calculating the decryption key is included in the read command 19 transmitted from the application unit 3 to the drive unit 2. Thus, it is not necessary for the reading means 5 to be informed about said key data and to read any key data from the medium 4, but only the requested user data. The key data 23 included in the read command 19 are then forwarded to the key calculation unit 7 which therefrom calculates the decryption key DK for decrypting the read user data 21. All other steps are identical as explained above with reference to FIG. 1.

Instead of including the key data from which the decryption key DK can be calculated in the read command 19, the decryption key DK may be directly included in the read command 19 so that no key calculation unit 7 is anymore required. However, the decryption key DK then has to be known in unencrypted form to the application unit 3 which involves a higher risk of loss of the decryption key when the application unit 3 is hacked.

There are several possibilities for the application unit 3 to know which key data to use for decrypting the user data. According to a first possibility the application can access a table of content stored on the medium 4 storing an information about which key data belong to which file of user data. This table enables the application to relate key identifiers to files. According to a second possibility a secure authenticated channel (SAC) can be established between the drive 2 and the application unit 3. This channel can then be used to communicate key data or a key data identifier. According to a third possibility the file name of an encrypted file may contain an identifier which can be sent by the application unit 3. The drive unit 2 can then relate this identifier to a specific key of the set of keys stored on the medium 4.

A third embodiment of a reproducing apparatus 1 is shown in FIG. 3. Therein re-encryption is used within the drive unit 2 before outputting user data to the application unit 3. As in the first embodiment shown in FIG. 1 an information as to the user data to be read from the medium 4 is included in the read command 19. However, after decryption of the user data 21 by the calculated decryption key DK in the decryption unit 8 the user data, now being in the clear, are re-encrypted by a re-encryption unit 10 using a regularly changing re-encryption key RK. In order to know which re-encryption key RK to use for re-encryption a re-encryption key can be requested from a certification authority 15 or generated on demand by the drive unit 2. After re-encryption of the user data by re-encryption unit 10 it (16) is outputted by the output unit 26 to the application unit 3.

Since the re-encryption key RK has also to be known to the application unit 3 in order to decrypt the user data therein, a secure authenticated channel 17, 18 between the drive unit 2 and the application unit 3 is established. One way to do this is to authorize the application running on the application unit 3 its public key is certified by a certification authority 15. Said public key is then used to establish the secure authenticated channel 17. The key calculation unit 9 may then verify the certification authority's signature.

After final authorization of the application the encrypted re-encryption key RK or any other data relating to the re-encryption key RK are transmitted from the key calculation unit 9 to the key calculation unit 11 of the application unit 3 via the secure authenticated channel 18. The key calculation unit 11 is thus able to calculate the re-encryption key RK such that the decryption unit 12 can decrypt the re-encrypted user data 16. It should be noted that the transmission lines 16, 17 and 18 are included in the bus of the reproducing apparatus 1. After decrypting the user data in decryption unit 12 it can be completely reproduced and rendered for playback by render unit 13.

A first embodiment of a reproducing apparatus 30 according to the invention comprising an application unit 31 and a drive unit 32, i.e. an apparatus for writing user data, is shown in FIG. 4. Therein an input means 33 of the application unit 31 receives user data to be stored on the medium 4, which user data 41 are transmitted to the drive unit 32 for encryption and storage. In addition, a write command 40 is transmitted from the command unit 34 to the command interface 35 specifying where said user data are to be stored on the medium 4 and including a key data information specifying which key data to use for encrypting said user data by the encryption unit 36. The location information 45 including the logical block address for the start of writing the encrypted user data 43 is forwarded to the writing means 38. The key data information 42 including a key data identifier is forwarded to reading means 39 for reading the key data indicated by said key data identifier from the medium 4. The read key data 44 are then inputted into the key generation means 37 generating the encryption key EK for encrypting the user data 41 in encryption unit 36. Alternatively, the application unit 31 may already encrypt the user data using said encryption key EK and transmit the user data to the drive unit 32 in encrypted form.

An alternative embodiment of a recording apparatus 30 is shown in FIG. 5. In this embodiment no reading means are required for reading any key data from the medium 4 since in the write command 40 the required key data for encryption are already included in encrypted form. Said encrypted key data 42 are provided from the command interface 35 to the key generation means 37 generating the encryption key EK for encrypting the received user data 41. The encrypted user data 43 are again stored on the medium 4 by writing means 38. In order to even avoid key generation means 37 it may also be possible that the write command 40 includes the encryption key EK in the clear which can directly be used by the encryption unit 36.

The method of securely rendering protected content according to the invention shall now be explained with reference to FIG. 6. Therein a system comprising several levels is shown. The first level is the application layer 50 which holds information on files, rights and assets (data). This information, contained in the Table of Content (TOC), is passive in the sense that the application layer 50 can use this information but it cannot enforce actions based on it. The second level is the file system layer 51, which is completely transparent. This level holds information on the translation of file requests into sector requests based on the file system meta data. The third level is the drive 52 containing the core of the Digital Rights Management (DRM) system. This level holds information on assets, rights and sectors.

File system data 61 present on the disc 53 is read during the mounting 62 of the disc 53. The resulting list of files 63 present on the disc 53 is reported to the application 50. Any DRM data 64 that is present on the disc 53 is read and decrypted (step 65) yielding asset identifiers 66 (asset ID), asset keys and a list of all actions on the encrypted data that are allowed (rights 67). The asset IDs 66 and associated rights 67 are reported to the application 50. Using rights and file information a comprehensive TOC 68 is generated and presented to the user.

Upon selection by the user (step 69) a file request 70 is issued to the file system layer 51. The file system layer 51 translates the file request 70 into a request for a block of sectors 71, and this block request 71 is relayed to the drive 52 where the legality of the request is checked (step 72). If the application 50 has not at this point reported to the drive 52 the asset ID 66 associated with the file the requested sectors belong to, then the DRM system cannot find and release the appropriate asset key. Consequently, any encrypted file data 73 retrieved cannot be decrypted in step 74.

The decrypted sectors 75 are sent across a Secure Authenticated Channel (SAC) through the file system layer 51, where the sectors 75 are associated with the file 76 of the original file request, to be securely delivered inside the trusted application where the content is subsequently rendered in step 77.

Optionally the trusted application 50 can be required to also report the intended operation on the requested file. The DRM system inside the drive 52 can then check if this intended use is compatible with the rights associated with the asset ID reported to be the one associated with the requested file. This is necessary to prevent the hacking of the TOC to lead to a collapse of the security system if the TOC is not generated using the file system and DRM data present on the disc but read from a separate file. In that case the trusted application could base its assessment of what constitutes an appropriate action for a given asset on erroneous information contained in the comprehensive TOC.

If a file is successfully rendered the rights for the associated asset might have changed. In that case the successful rendering needs to be reported to the DRM system inside the drive 52 (step 78), which then updates the DRM data 80 on the disc (step 79).

When the application needs an encrypted file, first a SAC is created between the application and the drive, unless it already exists. Then a request is sent via the SAC to the DRM system in the drive with the asset ID related to the file and the intended use, e.g. play or copy. The DRM checks the validity of the request and, if valid, prepares the decryption key and gives the application a “handle” for future reference to this key. When the application now needs blocks from this file, the handle is passed on to the drive together with the block request. The drive does not have to do any checking about the validity of the block request at this point. If the handle is valid, the blocks are decrypted and re-encrypted in the SAC key and then passed on to the application in the normal way.

The invention can thus be applied in any case where access to an entity, e.g. file, comprised of a collection of storage units, i.e. sectors or blocks, is facilitated by (software) layers, i.e. drivers, that translate the original request into a request for arrange of addresses on the storage device and where the properties of or the nature of the requested operation on the accessed entity can be used by the storage device the entity is stored on. This includes the use of storage devices such as optical disc systems and hard disc drives that implement (in the drive) advanced features such as digital rights management or allocation strategies.

It should be noted that the invention has been described above by way of a particular example illustrating decryption and encryption of user data as one particular way of processing the user data in the apparatus for reading or writing, respectively. However, the invention is not limited to said particular example. Other ways of processing the user data can be employed by said apparatuses and other—alternative or additional—pieces of processing information can be included in any read or write command forwarded to the apparatuses informing them about the intended use of the user data. Thus, the described decryption or encryption unit can also be generalized as processing means for processing the user data according to the specified processing information included in the corresponding read or write command.

1. Apparatus for reading user data stored block-wise in encrypted form on a storage medium (4), the storage of which is divided into blocks, comprising:
a command interface (6) for receiving and interpreting a read command, said read command including a user data information specifying which user data are to be read and a processing information specifying how to process said user data,
reading means (5) for reading user data from said storage medium,
processing means (8) for processing said user data according to said processing information, and
output means (26) for outputting said processed user data.

2. Apparatus according to claim 1, wherein said processing information specifies the use of decryption, re-encryption, an allocation strategy, real-time characteristics, acceptable number of retries on a read error of said user data.

3. Apparatus according to claim 1, wherein said processing information includes a key data information specifying which key data to use for decrypting said user data and wherein said processing means (8) comprises decryption means for decrypting said user data using said key data.

4. Apparatus according to claim 3,
wherein said read command includes the key data to be used for decrypting said user data, said key data being included in encrypted form, and
wherein said apparatus further comprises key decryption means (7) for decrypting said encrypted key data.

5. Apparatus according to claim 3,
wherein said key data are stored in encrypted form on said storage medium,
wherein said read command includes a key data identifier identifying the key data to be read from said storage medium (4) and to be used for decrypting said user data,
wherein said reading means (5) are further adapted for reading said identified key data, and wherein said apparatus further comprises key decryption means (7) for decrypting said encrypted key data.

6. Apparatus according to claim 3,
wherein said read command includes a re-encryption key data information specifying which re-encryption key data to use for re-encrypting said decrypted user data before outputting it, and
wherein said apparatus further comprises re-encryption means (10) for re-encrypting said decrypted user data before outputting it by said output means (26).

7. Method of reading user data block-wise stored in encrypted form on a storage medium (4), the storage of which is divided into blocks, comprising the steps of:
receiving and interpreting a read command, said read command including a user data information specifying which user data are to be read and a processing information specifying how to process said user data,
reading user data from said storage medium (4),
processing said user data according to said processing information, and
outputting said processed user data.

8. Apparatus for writing user data block-wise onto a storage medium (4), the storage of which is divided into blocks, comprising:
a command interface (35) for receiving and interpreting a write command, said write command including a user data information specifying which user data are to be written and a processing information specifying the how to process said user data,
processing means (36) for processing said user data according to said processing information, and
writing means (38) for writing said processed user data onto said storage medium.

9. Apparatus according to claim 8, wherein said processing information specifies the use of encryption, an allocation strategy, real-time characteristics, acceptable number of retries on a write error of said user data.

10. Apparatus according to claim 8, wherein said processing information includes a key data information specifying which key data to use for encrypting said user data and wherein said processing means (36) comprises encryption means for encrypting said user data using said key data.

11. Apparatus according to claim 10,
wherein said write command includes the key data to be used for encrypting said user data, said key data being included in encrypted form, and
wherein said apparatus further comprises key decryption means (37) for decrypting said encrypted key data.

12. Apparatus according to claim 10,
wherein said key data are stored in encrypted form on said storage medium,
wherein said write command includes a key data identifier identifying the key data to be read from said storage medium (4) and to be used for encrypting said user data,
wherein said apparatus further comprises:
reading means (39) for reading said identified key data from said storage medium, and
key decryption means (37) for decrypting said encrypted key data.

13. Method of writing user data block-wise onto a storage medium (4), the storage of which is divided into blocks, comprising the steps of:
receiving and interpreting a write command, said write command including a user data information specifying which user data are to be written and a processing information specifying how to process said user data,
processing said user data according to said processing information, and
writing said processed user data onto said storage medium (4).

14. Computer program product comprising computer program code means for causing a computer to perform the steps of the method as claimed in claim 7 or claim 13 when said computer program is run on a computer.
